(19) United States
(12) Patent Application Publication
(10) Pub. No.: US 2007/0120018 A1
(43) Pub. Date: May 31, 2007

(54) Multiple feather kite

(76) Inventor: R. Jed Katzman, Fairfield, CT (US)

Correspondence Address: Anthony H. Handal;Brown Rudnick Berlack Israels LLP, One Financial Center, Boston, MA, 02111, US

(21) Appl. No.: 11/603,429

(22) Filed: Nov. 22, 2006

Related U.S. Application Data
(60) Provisional application No. 60/739,836, filed on Nov. 28, 2005.

(51) Int. Cl. B64C 31/06

(52) U.S. Cl. 244/153 R

(57) ABSTRACT

A kite comprising a plurality of natural bird feathers is disclosed. The kite includes a fuselage member shaped like a feather. In addition, the kite includes a fuselage support member which is secured to the fuselage member. The kite also includes a first and a second wing member, both of which are shaped like feathers. A first wing support member is secured to the first wing member and a second wing support member is secured to the second wing member. The first wing support member and the second wing support member are secured to or integral with each other and are secured to the fuselage support member.

### RELATED APPLICATION INFORMATION

This patent application takes the priority of U.S. Provisional Application No. 60/739,836, filed in the U.S. Patent and Trademark Office on Nov. 28, 2005. The entire contents are incorporated herein by reference.

### BACKGROUND

1. Technical Field

The present invention relates to lightweight kites made of contoured stiff members, such as natural bird feathers or stiff foam plastic.

2. Background of the Invention

Kites have been known since antiquity. Extensive development and experimentation have resulted in numerous configurations from classic diamonds and boxes to elaborate sculptural masterpieces. Construction techniques generally involve paper and small gauge wooden support struts, although modem kites often use other materials such as likely polyethylene and plastic support struts.

### SUMMARY OF THE INVENTION

In accordance with the present invention, a kite is provided which is made totally of stiff elongated members. The present invention allows fast and easy construction of the kite, as well as packaging in easy to merchandise packages, without the need for carefully rolling planar paper members around wooden struts, as is done with the most common prior art designs.

The inventive kite also provides the advantage of working with relatively inexpensive lines, such as a sewing thread, which is more conveniently carried than conventional kite flying string. The inventive kite also has the advantage of being constructed of common natural materials, which are sturdy and allow for easy construction and adjustment of the inventive kite.

More particularly, in accordance with the present invention, a kite comprises a plurality of natural bird feathers. The kite comprises natural bird feathers oriented to curve upwardly from a center of the kite to tips of the feathers in a flying position. The feathers, are flight feathers and are oriented with narrow leading edges facing toward wind, and a wide trailing edge faces in into the wind. The kite further comprises a fuselage member secured to a pair of wing members. The kite has a pair of wing members which are inserted into each other. One of the pair of wing members terminates in a natural quilt narrow region and the other of the pair of wing members terminates in a cut open end large enough to receive the narrow region. The fuselage may be a male peacock display feather. The fuselage may be secured to the wing members by a rubber band. The kite may have support members are plastic straws.

In accordance with the invention, a method of inciting birds may comprise flying a kite comprising feathers as aerodynamic structural elements.

### BRIEF DESCRIPTION OF THE DRAWINGS

The structure and method of construction of a kite constructed in accordance with the invention will be understood from the following drawings, taken in conjunction with the description below, and in which:

FIG. 1 is a plan view of one embodiment of the inventive kite, viewed from the top side;

FIG. 2 is a cross sectional view along lines 2-2 of FIG. 1;

FIG. 3 is a cross-sectional view of a wing like structural member of the inventive kite along lines 3-3 of FIG. 1;

FIG. 4 is a perspective view of the inventive kite as it appear in a launching position;

FIG. 5 is a perspective view of a kite as it would appear in a flying position;

FIG. 6 is a plan view of a kite as it would appear in a package;

FIG. 7 is a perspective view of a feather end used as a right wing-like member;

FIG. 8 is another perspective view of a feather used as a left wing-like member;

FIG. 9 is a plan view illustrating the joinder of wing like members;

FIG. 10 is an exploded perspective view showing an alternative tubular fastener comprising a pair of tubes secured to each other, to implement another embodiment of the present invention;

FIG. 11 is a view illustrating the assembly of an alternative embodiment of the inventive kite.

### DETAILED DESCRIPTION OF THE INVENTION

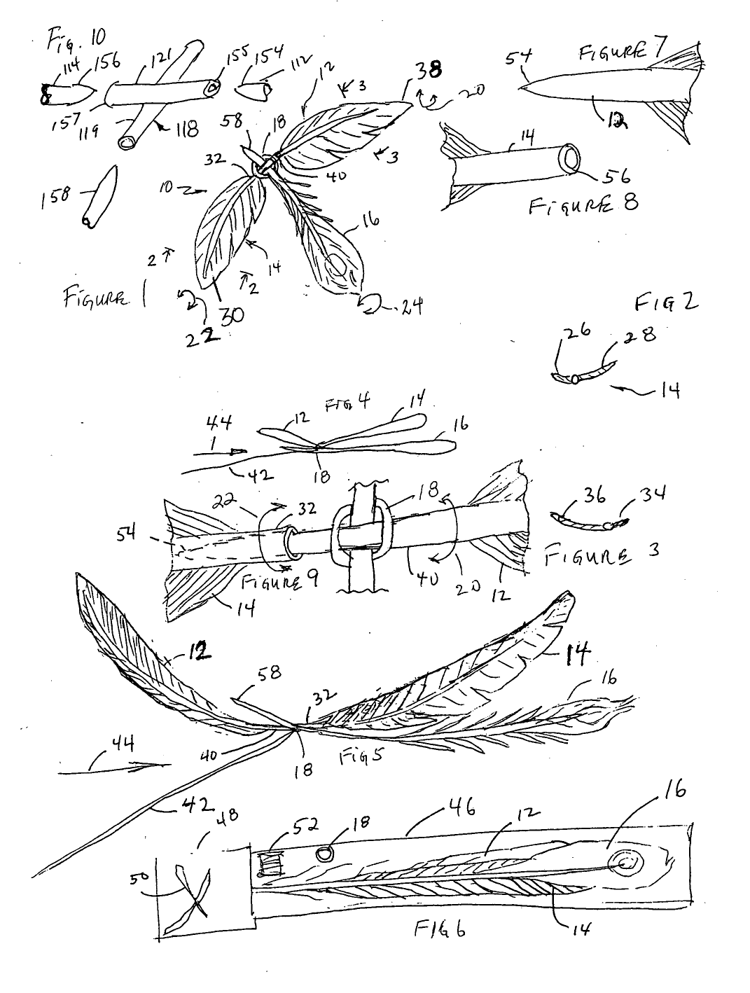

Referring to FIG. 1, a kite 10 constructed in accordance with the present invention is illustrated. Kite 10 comprises a right wing 12 and a left wing 14. In FIG. 1, kite 10 is illustrated in top plan view, as it might be viewed from a point above the kite during flight. Wings 12 and 14, which are flight feathers, are attached to a main body 16. Right wing 12, left wing 14 and main body 16 are all, in accordance with the preferred embodiment of the present invention, made of feathers.

Right wing 12 and left wing 14 are approximately 32 cm in length. As more fully appears below, their configurations are all mirror images of each other, being taken from opposite wings of a natural bird, such as a seagull, turkey or other suitable bird. The main body 16, in accordance with the preferred embodiment of the present invention, is taken from the tail of a male peacock, being one of the feathers displayed by the bird during mating dances. In accordance with the preferred embodiment of the present invention, main body 16 comprises a feather having a length of approximately 30-40 cm, for best results. The present invention is not limited to the use of a feather with a length of approximately 30-40 cm, other lengths will work, often well, depending on the type of thread used, wind conditions, kite tuning, etc.

As more fully appears below, feathers 12 and 14 are telescoped into each other and rotated to a desired configuration, which may be precisely determined by trial and error within the general guidelines detailed below, in view of the substantial uniqueness of each feather. A rubber band 18 is used to bind feathers 12 and 14 to fuselage feather 16. Rubber band 18 may have a diameter of approximately 1 cm. Alternatives to rubber band 18 may be sewing thread, raffia or string. Alternatively, glue may be employed.

As indicated above, tuning of kite 10 will improve performance. More particularly, tuning of the operation of kite 10 may be achieved by rotating feather 12 in the directions of arrows 20. Tuning of the operation of kite 10 may be achieved by rotating feather 14 in the directions of arrows 22. Tuning of the operation of kite 10 may be achieved by rotating feather 16 in the directions of arrows 24.

The orientation and selection of feathers 12 and 14 is important to good performance. As illustrated in FIG. 2, feather 14 is selected for its shape having an upwardly directed leading edge 26 as well as an upwardly directed trailing edge 28. At the same time, its tip 30 is also upwardly directed. More particularly, at its base 32, feather 14 gently curves upwardly. In addition, leading edge 26 is substantially shorter than trailing edge 28.

The orientation and selection of feather 12 is also important to good performance. As illustrated in FIG. 3, feather 12 is selected for its shape having an upwardly directed leading edge 34 as well as an upwardly directed trailing edge 36. At the same time, its tip 38 is also upwardly directed. More particularly, at its base 40, feather 12 gently curves upwardly. In addition, leading edge 34 is substantially shorter than trailing edge 36.

Turning now to FIG. 4, initially, the kite is tuned by adjusting the angle between the “wings” to be at right angles to fuselage 16, in much the same manner as an airplane. A sewing thread 42 is tied to the joint between the “wings” and the fuselage. One then lets the kite out about one meter on sewing thread 42 with sewing thread 42 positioned just slightly below the horizontal, as illustrated in FIG. 4. Kite 10 should face the wind which blows in the direction of arrow 44. If the wings are correctly positioned, at first the kite should fly horizontally and dip towards the ground.

Once horizontal plate is achieved, the wings should be rotated slightly back, that is with their leading edges slightly elevated in order to aim left. The kite should then rise. More thread should be let out and slight adjustments made as the thread is led out. If spinning occurs, the process may be begin again. Alternatively, fuselage 16 may be slid to the left or right, which should decrease the size of one wing. Alternatively, tilting one wing forward or back may help balance the kite. Given the individual nature of bird feathers, trial and error indicates the proper direction of adjustment and the magnitude of adjustment. If the kite flies to one side, care should be taken to make sure that the wings and tail form in a symmetrical T-configuration at right angles.

While flying the kite, it is advisable to keep between 1.5 and 2 meters of thread dangling between the hands so that the same can be easily and quickly let out or pulled in to achieve stability. Once sufficient thread has been let out, the kite will assume a flying configuration closer to that illustrated in FIG. 5. Flight occurs most effectively in a steady breeze. Instability may be cured in many instances by letting out more kite string.

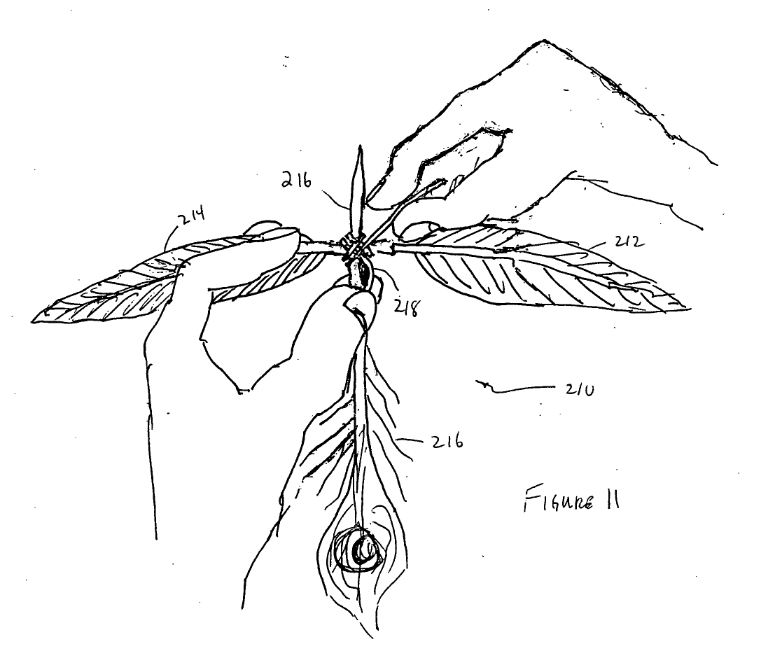

Turning now to Figure 6, in accordance with the preferred embodiment of the present invention, the inventive kite 10 may be shipped in a convenient package consisting of an elongated envelope 46, preferably made of clear plastic. Envelope 46 is closed by a simple folded paper closure 48, of standard design, which may have an illustration 50 in a conventional manner for packaging. Envelope 46 contains a spool of thread 52, 1 or more rubber bands 18, and feathers 12, 14 and 16.

As illustrated in FIG. 7, feather 12 terminates in its natural quill point 54. Feather 14 is cut to form an open tubular end 56, as illustrated in FIG. 8.

As illustrated in FIG. 9, when it is desired to assemble kite 10, natural quill point 54 is inserted into tubular end 56 to form a jam-fitted joint between feathers 12 and 14. Rubber band 18 is then wrapped around the quills at bases 32 and 40, and point 58 of fuselage feather 16 is passed through rubber band 18. The result is a secure adjustable joint between feathers 12, 14 and 18, as illustrated most clearly in FIG. 9.

In the current application, alternative embodiments, sharing similar, analogous or corresponding parts, have those parts numbered with numbers which are a multiple of 100 greater than the corresponding or an analogous parts in the embodiment of FIG. 1-9.

As an alternative to rubber band 18, in the embodiment of FIGS. 1-9, FIG. 10 shows the alternative of a tubular fastener 118 comprised of a tube 119 secured to a tube 121. A feather 112 has its point 154 inserted into end 155 of fastener 118. In a similar fashion, feather 114 has its end 156 inserted into end 157 of fastener 118. Fastener 118, with points 154 and 156 jam fit into it securely holds the inventive kite together, while allowing adjustment as described above. Tubular fastener 118 is made of plastic having good memory like a spring and may comprise the same material as an ordinary plastic straw.

Still yet another alternative is for string or raffia 218 to be used to secure feathers 212 and 214 of kite 210 to a fuselage feather 216, as illustrated in FIG. 11. This may be most easily done by grasping feather 216 between the thumb and ring finger of the left-hand while holding string or raffia 218 against said feather 216. At the same time, one holds feather 214 between the index finger and middle finger of the left-hand, while tying string or raffia 218 with the right hand, grasping the same between the thumb and index finger of the right hand. String or raffia 218 should be wrapped at least four times on each to angle, forming an X-shaped string knot. Care should be taken to tie both arms of the “X” with equal tension and with the feathers at right angles to each other. The same should be tied tightly enough to prevent undesired rotation during flight, while still allowing rotation by hand.

While the employment of natural bird feathers is believed to be the most cost-effective and substantially technologically effective solution, it is possible to replace the feathers with, for example, Styrofoam plastic members glued to quills made of balsa wood, plastic I-beams, plastic straws or similar materials and shapes.

It is the same that a T-shaped, adjustable kite that may be flown using a light-weight thread consisting of three inverted bird feathers comprising two opposing flight feathers inserted one into another as wings and one tail feather bound and centered to the wings as fuselage. The present invention provides for kits for toy kites which utilize bird wing shapes, light-weight materials and hollow support members.

The present invention has the advantage of utilizing feather by-products of the poultry industry to produce light-weight, aerodynamic and highly adjustable kites.

The flight feathers from birds are not symmetrical. Their aerodynamics relate to their position on a bird's wing. Each feather has a front side, a rear side, a top side, and an underside. These feathers are curved, light weight, strong, and vary in size and shape. Each feather is identical yet opposite in shape to the feathers on the bird's opposing wing. Identical and nearly identical flight feathers from opposing wings have hollow quills that are similar in diameter.

Unlike flight feathers, tail feathers from birds are generally symmetrical. Long tail feathers are generally longer than either of the flight feathers used as a fuselage.

The invention uses two opposing flight feathers and one long tail feather. One flight feather's pointed quill tip is cut off at the widest part of the quill end's hollow shaft. The opposing flight feather's remaining quill tip is then inserted firmly into the hollow shaft of the first. The resulting friction between the two opposing feathers allow them to be spun one within the other yet holds them in position.

The two flight feathers are rotated until their positions mirror one another. Their aerodynamic direction remains the same. Unlike the way flight feathers grow from a bird's wing, the two attached feathers are turned upside down so that the feather curves face up.

A single tail feather is centered and bound or lashed firmly under the two connected flight feathers near it's quill end. The method of attachment must insure that the wings and fuselage can be rotated independent of one another and various materials may be used such as rubber bands, thread, or raffia.

Unlike flight feathers, an individual feather is generally symmetrical in shape, that is to themselves.

Two opposing flight feathers of similar shape from a bird configured and combined is utilized and configured, and is known to be a method of attachment attached by lashing or banding together (referring to FIG. 1) at the vertex of crossing members. This method of attachment affords spinning of feathers within said attachment allowing for adjustment of wing and tail angles and lengths.

All kites are of various shapes which may be attached by a string to a fixed location to rise vertically in wind. A difficulty is encountered with all kites wherein the weight of the support structure must be light enough to be lifted yet strong enough to support the kite shape. Flight feathers from an actual bird are inherently light, strong and comprise a shape which when supported in a breeze, catch air underneath and create lift above.

The naturally occurring inverted cup-shaped curve in bird wings and feather shapes are designed to maximize the amount of air caught under each wing as the bird flaps. This shape allows the bird to rise by flapping its wings in no wind. Once airborne, this same shape creates negative air pressure above the wing to create lift. In nature, the actual bird is the support structure.

In the current invention, the feathers themselves and their means of attachment are the support structure. The quill of any feather may be cut off and the quill of another feather of similar size may be inserted into the first, creating a support for each wherein relation to each other remains in place. If a string is tied to the vertex of this structure and is placed in wind, it will create a whirlwind of sorts.

In the current invention, when opposing flight feathers of identical, or nearly identical shapes are inserted into one another, a symmetry is created. By itself, this symmetrical two feather arrangement may be flown like a kite but is rather unstable. When these two attached feathers are connected to a third member in a T configuration, a bird-like shape is formed. In the present invention, if a string is attached at the vertex of this feather T and this shape is inverted, this configuration may be flown as a kite.

What is claimed is:

1. A kite comprising a plurality of natural bird feathers.

2. A kite as in claim 1, wherein said natural bird feathers are oriented to curve upwardly from a center of said kite to tips of said feathers in a flying position.

3. A kite as in claim 2, wherein said feathers are oriented with narrow leading edges facing toward wind, and wide trailing edges facing in a direction of said wind.

4. A kite as in claim 3, wherein said kite comprises a fuselage member secured to a pair of wing members.

5. A kite as in claim 4, wherein said pair of wing members are inserted into each other.

6. A kite as in claim 5, wherein one of said pair of wing members terminates in a natural quilt narrow region and the other of said pair of wing members terminates in a cut open end large enough to receive said narrow region

7. A kite as in claim 5, wherein said fuselage is a male peacock display feather.

8. A kite as in claim 7, wherein said fuselage is secured to said wing members by a rubber band.

9. A kite comprising:
a fuselage member shaped like a feather;
a foam plastic member;
a fuselage support member secured to said fuselage member;
a first wing member shaped like a feather;
a first wing support member secured to said first wing member;
a second wing member shaped like a feather;
a second wing support member secured to said first wing member, wherein said first wing support member and said second wing support member are secured to or integral with each other and secured to said fuselage support member.

10. A kite as in claim 9, wherein said support members are plastic straws.

11. A method of inciting birds comprising flying a kite comprising feathers as aerodynamic structural elements.
